(19) United States
(12) Patent Application Publication
(10) Pub. No.: US 2008/0062068 A1
(43) Pub. Date: Mar. 13, 2008

(54) Spheroidal Multi-Solenoid Antenna

(75) Inventor: Boris Kokorin, Moscow (RU)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: EMF TECHNOLOGIES CORPORATION, THE VALLEY (SF)

(21) Appl. No.: 10/586,506

(22) PCT Filed: Jan. 14, 2005
(86) PCT No.: PCT/IB05/00074

§ 371 Date: Sep. 14, 2007

(30) Foreign Application Priority Data
Jan. 16, 2004 (ZA) 2004/0354

(51) Int. Cl. H01Q 1/36

(52) U.S. Cl. 343/895

(57) ABSTRACT

A spheroidal antenna, having a spheroidally configured winding. The winding comprises a three-dimensional spiral about an axis with the radius of turns of the winding progressively increasing and then decreasing. The winding may be of a multi-solenoid conductor. It may also be composite, having a primary conductor with a secondary conductor wound toroidally about the primary conductor. The antenna may have a plurality of windings. Two windings may be in the same layer, with the turns thereof being laterally adjacent each other. The antenna may be multi-layered, with the turns of one layer being at an angle to the turns of a super-adjacent layer. The antenna may have a hollow spheroidal former.

THIS INVENTION relates to an antenna.

According to the invention there is provided a spheroidal antenna.

The antenna may have at least one winding that is spheroidally configured.

The antenna may have a spheroidally configured winding, ie a three-dimensional spiral about an axis, the radius of turns of the winding progressively increasing and then decreasing.

The winding may be of a multi-solenoid conductor.

Further, the antenna may have a composite winding, comprising a primary conductor with a secondary conductor wound toroidally about the primary conductor, in a Tokamak manner. Either, or both, of the primary and secondary conductors may be of the multi-solenoid type.

The antenna may have a plurality of windings, each having a start and an end. The turns of a first winding may be laterally adjacent the turns of a second winding. The antenna may have a plurality of layers. With such a multi-layer embodiment, the turns of a winding in one layer may be at an angle to the turns of a super- or sub-adjacent layer.

The antenna may have a spheroidal former on which the or each winding is wound. The former may be hollow.

The invention will now be described, by way of examples, with reference to the accompanying diagrammatic drawings, in which:

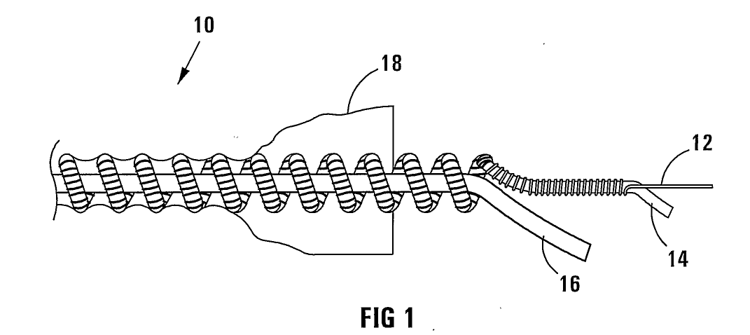

FIG. 1 shows a first order multi-solenoid conductor;

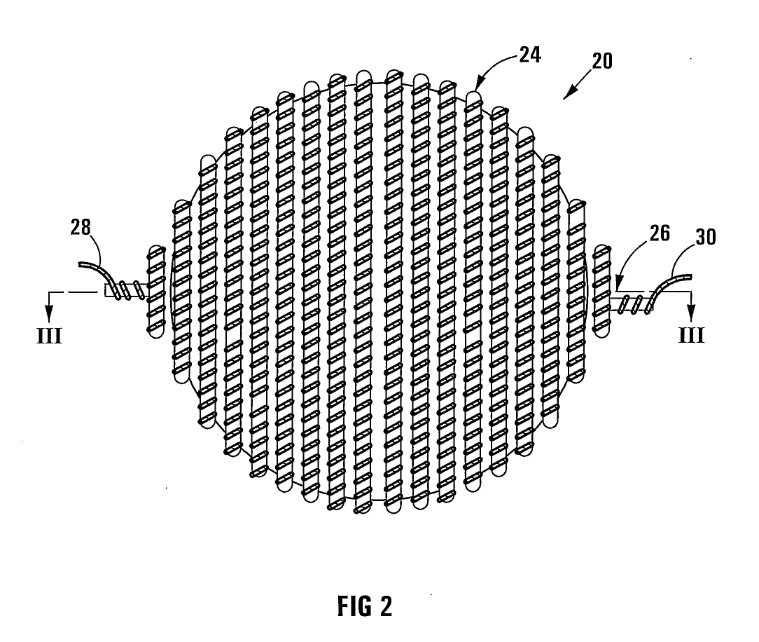

FIG. 2 shows a plan view of a first embodiment of an antenna in accordance with the invention, which uses the first order multi-solenoid conductor of FIG. 1;

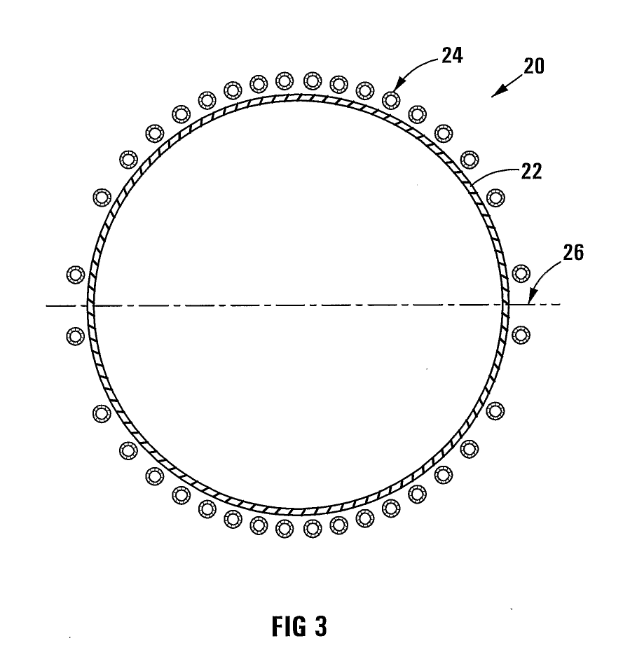

FIG. 3 shows a sectioned view of the antenna of FIG. 2 along line III-III;

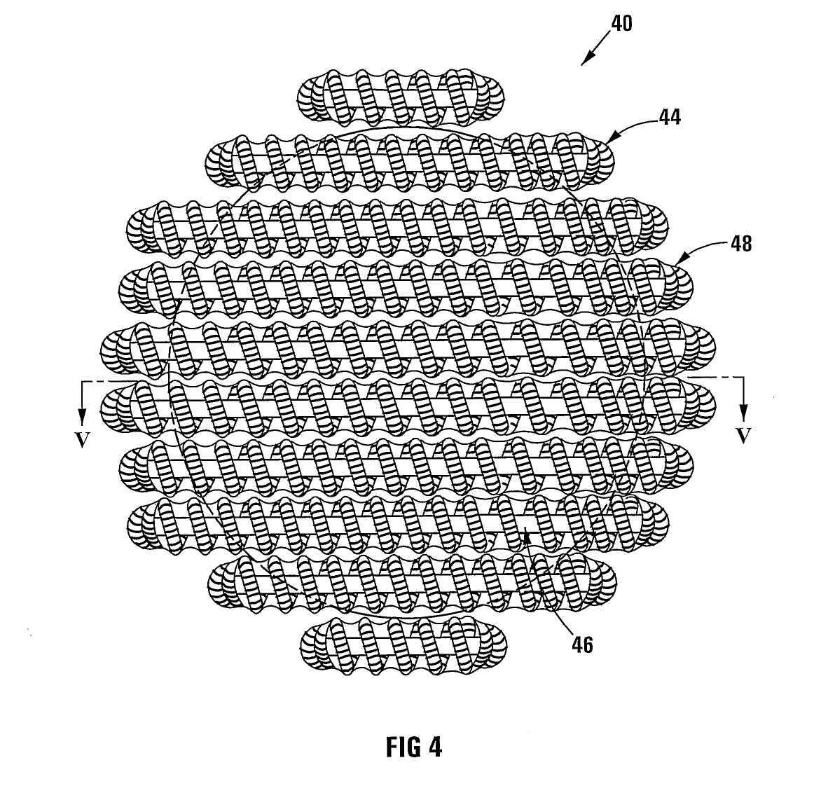

FIG. 4 shows a plan view of a second embodiment of an antenna in accordance with the invention;

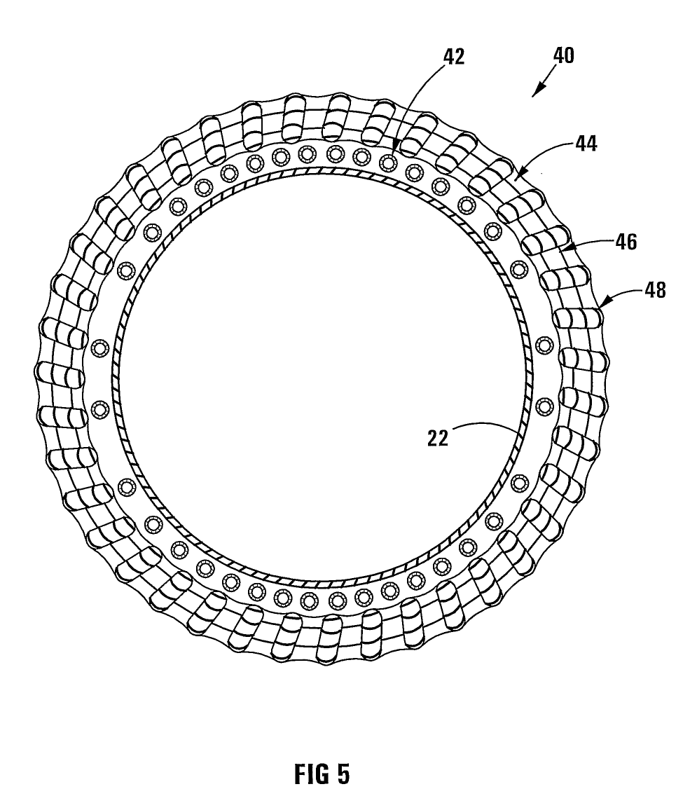

FIG. 5 shows a sectioned view of the antenna of FIG. 4 along line V-V;

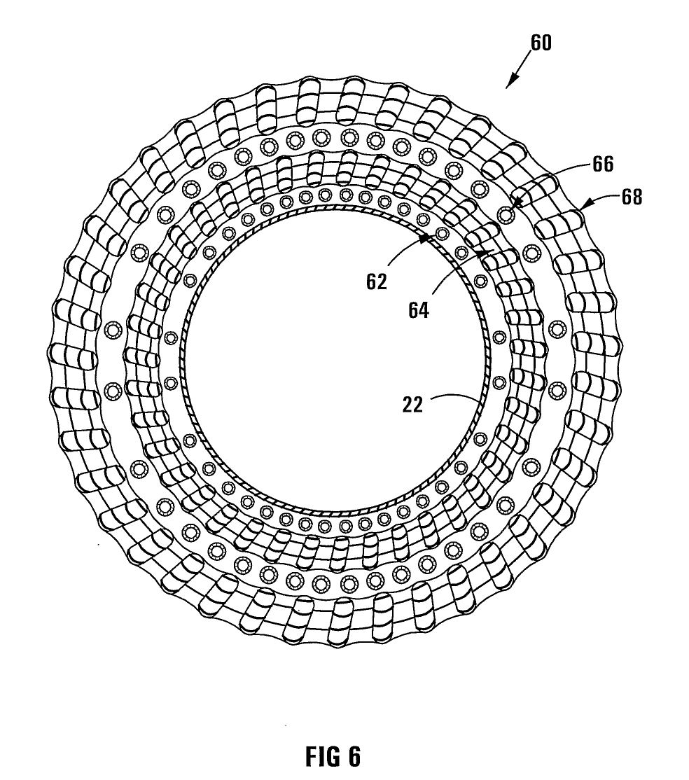

FIG. 6 shows a sectioned view of a third embodiment of an antenna in accordance with the invention; and

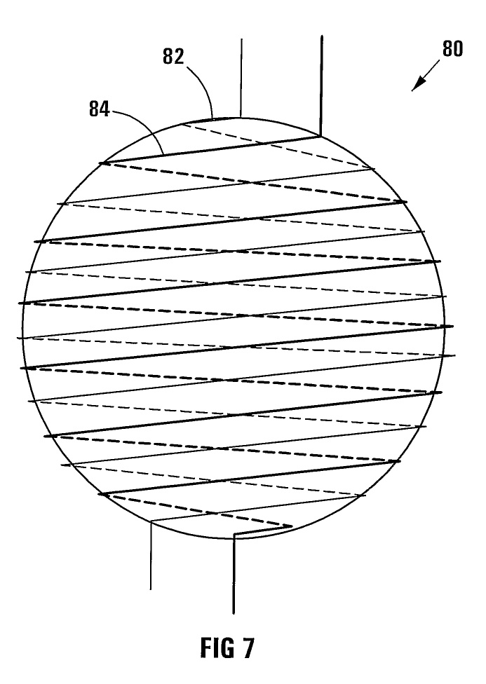

FIG. 7 shows a fourth embodiment of an antenna in accordance with the invention.

Referring to FIG. 1, a length of a first order multi-solenoid conductor is referred to generally by reference numeral 10. It will be seen that the conductor 10 comprises a length of conducting wire 12 that is wound helicoidally about a secondary insulating fibre core 14, which, in turn, is helicoidally wound about a primary insulating fibre core 16. An insulating plastic covering 18 covers the wire 12 and secondary core 14. The primary core 16 has a diameter of about 1.5 mm; the secondary core 14 a diameter of about 1.2 mm; and the wire 12 has a thickness of about 0.4 mm. Thus, the conductor 10 has a diameter of about 5.5 mm. The pitch of the wire 12 wound on the secondary core 14 is about 1 mm and the pitch of the secondary core 14 on the primary core 16 is about 4 mm. The wire 12 is of copper or aluminium. It will be appreciated that, if the wire 12 were to be replaced by a further core, on which the wire is helicoidally wound, this further core with the wire thereon being helicoidally wound on the secondary core, a second order multi-solenoid would result.

Referring now to FIGS. 2 and 3, a first embodiment of a spheroidal antenna 20 in accordance with the invention is shown. It will be seen that the antenna 20 has a hollow spheroidal former 22 on which there is a spheroidal winding 24 comprised of the second order multi-solenoid conductor 10. It will be seen that the conductor 10 is wound on the former 22 in a spheroidal manner about an axis 26 of the former 22, with the turns thereof having a progressively increasing and then decreasing radius. The winding 24 has ends 28 and 30, one of which constitutes a start of the winding 24 and the other the end thereof.

Referring to FIGS. 4 and 5, a second embodiment 40 of a spheroidal antenna in accordance with the invention is shown. This embodiment 40 also has a spheroidal former 22 on which there are an inner spheroidal winding 42 and an outer composite spheroidal winding 44. The inner winding 42 is the same as the winding 24 of the embodiment 20. The outer winding 44 comprises a conductor 46 that is the same as that of the windings 42 and 22, on which is wound a further second order multi-solenoid conductor 48, in a Tokamak manner. Thus, this antenna 40 has two windings arranged in two layers. It will further be appreciated that the windings 42 and 44 are about orthogonal axes, so that the turns thereof are at right angles to one another.

A further embodiment of a spheroidal antenna in accordance with the invention is shown in FIG. 6, by reference numeral 60. This antenna 60 has four layers of windings 62, 64, 66 and 68 on a former 22. These windings are essentially similar and are each like the winding 24, with the windings 62 and 66 having the same axis and the windings 64 and 68 having the same axis, the two axes being orthogonal, such that the turns of each layer are at right angles to the turns of the layer above and/or below.

A still further embodiment of a spheroidal antenna 80 in accordance with the invention is shown in FIG. 7. This antenna 80 has two similar windings 82 and 84 that are each similar to the winding 22 and are wound about the same axis to be interlaced so that the turns of the two windings are laterally adjacent one another.

1. An antenna, characterized therein that it is spheroidal.

2. The antenna as claimed in claim 1, characterized therein that it has a winding that is spheroidally configured.

3. The antenna as claimed in claim 2, characterized therein that the winding comprises a three-dimensional spiral about an axis, the radius of turns of the winding progressively increasing and then decreasing.

4. The antenna as claimed in claim 2, characterized therein that the winding is of a multi-solenoid conductor.

5. The antenna as claimed in claim 2, characterized therein that the winding if composite, comprising a primary conductor with a secondary conductor wound toroidally about the primary conductor.

6. The antenna as claimed in claim 5, characterized therein that the primary conductor is a multi-solenoid conductor.

7. The antenna as claimed in claim 5, characterized therein that the secondary conductor is a multi-solenoid conductor.

8. The antenna as claimed in claim 2, characterized therein that it has a plurality of windings, each winding having a start and an end.

9. The antenna as claimed in claim 8, characterized therein that turns of a first winding are laterally adjacent the turns of a second winding.

10. The antenna as claimed in claim 8, characterized therein that it has a plurality of layers.

11. The antenna as claimed in claim 10, characterized therein that the turns of a winding in a first layer are at an angle to turns of a super-adjacent second layer.

12. The antenna as claimed in claim 2 characterized therein that it has a spheroidal former on which the or each winding is wound.

13. The antenna as claimed in claim 12, characterized therein that the former is hollow.

14. (canceled)
